(19) United States
(12) Patent Application Publication
(10) Pub. No.: US 2016/0020516 A1
(43) Pub. Date: Jan. 21, 2016

(54) Wireless Communication Antenna Module and Portable Terminal Comprising Same

(71) Applicant: AMOTECH CO., LTD., Incheon (KR)

(72) Inventors: Eul-Young Jung, Incheon (KR); Hyung-Il Baek, Gyeonggi-do (KR); Beom-Jin Kim, Gyeonggi-do (KR); Chi-Ho Lee, Incheon (KR); Do-Hyung Lee, Incheon (KR)

(73) Assignee: AMOTECH CO., LTD., Incheon (KR)

(21) Appl. No.: 14/768,172

(22) PCT Filed: Feb. 14, 2014
(86) PCT No.: PCT/KR2014/001231

§ 371 Date: Sep. 21, 2015

(30) Foreign Application Priority Data
Feb. 14, 2013 (KR) 10-2013-0015840
Feb. 14, 2014 (KR) 10-2014-0017217

(51) Int. Cl. H01Q 7/00; H01Q 1/24

(52) U.S. Cl. CPC H01Q 7/00; H01Q 1/243

(57) ABSTRACT

Disclosed are a wireless communication antenna module and a portable terminal including the same for maximizing the performance of an antenna by mounting a radiation sheet so as to partially overlap with an antenna sheet. The disclosed wireless communication antenna module comprises: the antenna sheet provided with a radiation pattern and is installed on a portable terminal main body or a battery pack; and the radiation sheet installed on a rear-surface housing of the portable terminal, wherein an overlapping area is formed by laminating the antenna sheet and the radiation sheet in an overlapping manner when the portable terminal main body and the radiation sheet are coupled.

### TECHNICAL FIELD

The present invention generally relates to a wireless communication antenna module. More particularly, the present invention relates to a wireless communication antenna module that is installed in a portable terminal and communicates with a wireless communication antenna module of another portable terminal, and a portable terminal having the wireless communication antenna module.

The present application claims the benefit of Korean Patent Application No. 10-2013-0015840, filed on Feb. 14, 2013, Korean Patent Application No. 10-2014-0017217, field on Feb. 14, 2014, the contents of which are entirely incorporated herein by reference.

### BACKGROUND ART

With technological development, portable terminals such as a mobile phone, a PDA, and PMP, a navigation system, and a laptop additionally provides DMB, wireless internet, and a near field communication function of devices, in addition to basic functions such as calling, playing video/music, and navigation. Accordingly, portable terminals have a plurality of antennas for wireless communication such as wireless internet and Bluetooth.

Further, recently, functions such as information exchange between terminals, payment, ticket advance purchase, and searching using near field communication (NFC) are applied to portable terminals. To this end, these portable terminals are equipped with an antenna module for portable terminals (that is, near field communication antenna module) used in a near field communication type. The wireless communication antenna module is a non-contact local wireless communication module, which is an RHD using a frequency band of about 13.56 Hz, and transmits data between terminals at a short distance of about 1.0 cm. A wireless communication antenna module is used in various areas such as transmission of product information at a supermarket or a store or transmission of travel information of visitors, traffic, access control, and a locking system, in addition to payment.

Recently, the market of portable terminals such as a tablet PC or a smartphone has rapidly increased. Portable terminals recently include functions such as information exchange between terminals, payment, advance ticket purchase, and searching using local communication (that is, NFC). Accordingly, there is an increased demand for a wireless communication antenna module that is used for near field communication. In relation to a wireless communication antenna module, there are Korean Patent Application Publication No. 10-2009-0126323 (titled, “NFC module, particularly for mobile telephone”) and Korean Patent No. 104098263 (titled, “NFC loop antenna).

A differential antenna type of wireless communication antenna module is usually used for portable terminals. The differential antenna type of wireless communication antenna module receives signals from an external terminal through a radiator pattern, in which the signals are transmitted only through a signal line connected to one end of the radiator pattern. Accordingly, the intensity of a received signal is low in the wireless communication antenna modules of the related art, so the reception performance is decreased and the reader mode recognition distance is reduced.

### DISCLOSURE

### Technical Problem

Accordingly, the present invention has been made keeping in mind the above problems occurring in the prior art, and an object of the present invention is to provide a wireless communication antenna module that maximizes antenna performance by stacking a radiation sheet having an opening and a slot on an antenna sheet.

### Technical Solution

In order to accomplish the above object, the present invention provides a wireless communication antenna module that includes: an antenna sheet having a radiation pattern formed in a loop shape by winding a wire several times along an edge of a non-patterned portion; and a radiation sheet stacked on the antenna sheet, in which the radiation sheet has an opening and a plurality of slits, and the opening and the slits are stacked to form an overlap area with the radiation pattern.

The edge of the opening formed in the radiation sheet may be stacked on an area where the radiation pattern is formed. The edge of the opening formed in the radiation sheet may be stacked on the edge of the non-patterned portion.

The radiation sheet may include; a first slit extending in a first direction from a first side of the opening; and a second slit extending in a second direction from a second side of the opening. The second slit may be disposed opposite to the first slit.

The side connected to the first side of the opening of the first slit may be stacked on an area where the radiation pattern is formed, and the side connected to the second side of the opening of the second slit may be stacked on an area where the radiation pattern is formed.

The wireless communication antenna module may further include a protective sheet overlapping the opening and the slits.

In order to accomplish the above object, the present invention provides a portable terminal that includes: a portable terminal body; a rear housing mounted on a rear side of the portable terminal body; and a wireless communication antenna module mounted inside the rear housing, in which the wireless communication antenna module is the wireless communication antenna module of any one of claims 1 to 6. A radiation sheet of the wireless communication antenna module may be included in the rear housing.

### Advantageous Effects

According to the present invention, since an opening and a plurality of slits are formed in a radiation sheet and the radiation sheet is stacked on a radiation pattern in the wireless communication antenna module, the radiation area of a magnetic field is increased by magnetic-coupling between the radiation pattern and the radiation sheet and the magnetic flux loop is increased by the radiation sheet, so the antenna performance can be maximized.

### DESCRIPTION OF DRAWINGS

FIGS. 1 to 6 are diagrams illustrating a wireless communication antenna module according to an embodiment of the present invention.

FIGS. 7 to 9 are diagrams illustrating a portable terminal having a wireless communication antenna module according to an embodiment of the present invention.

FIG. 10 is a diagram illustrating current flow when a wireless communication antenna module according to an embodiment of the present invention is operated.

FIGS. 11 to 13 are diagrams illustrating antenna characteristics of a wireless communication antenna module according to an embodiment of the present invention.

### MODE FOR INVENTION

Exemplary embodiments of the present invention will be described below with reference to the accompanying drawings in order for those skilled in the art to be able to easily implement the technical spirit of the present invention. First, in the specification, in adding reference numerals to components throughout the drawings, it should be noted that like reference numerals designate like components even though components are shown in different drawings. In describing the present invention, well-known functions or constructions will not be described in detail since they may unnecessarily obscure the understanding of the present invention.

Hereafter, a wireless communication antenna module according to an embodiment of the present invention and a portable terminal having the wireless communication antenna module are described in detail with reference to the accompanying drawings. The wireless communication antenna module according to the embodiment of the present invention can be applied to near field communication such as Bluetooth and a wireless communication antenna module applied to an NFC band is exemplified.

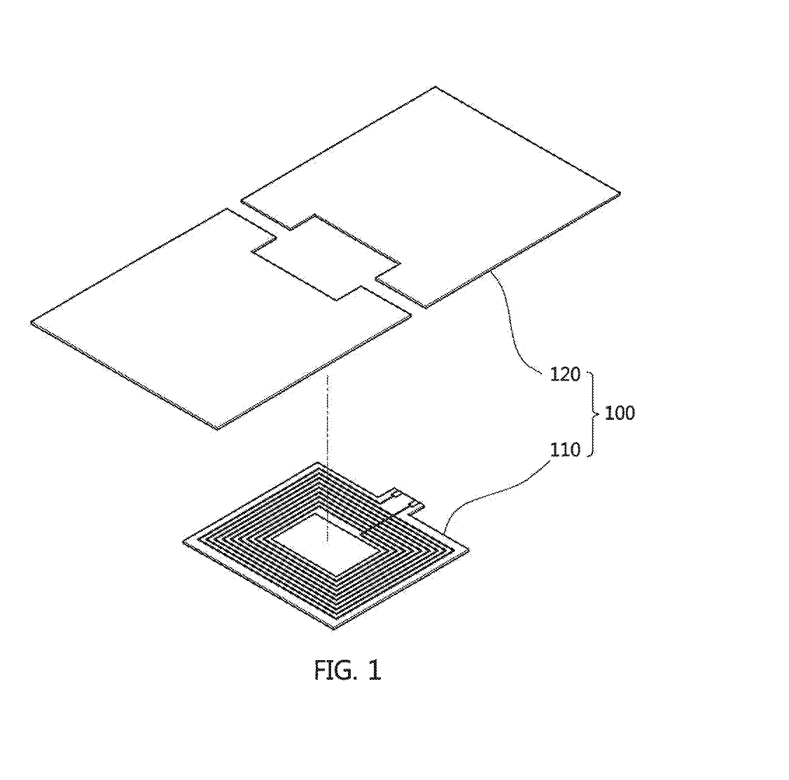

FIGS. 1 to 6 are diagrams illustrating a wireless communication antenna module 100 according to an embodiment of the present invention. As shown in FIG. 1, the wireless communication antenna module according to an embodiment of the present invention includes an antenna sheet 110 and a radiation sheet 120.

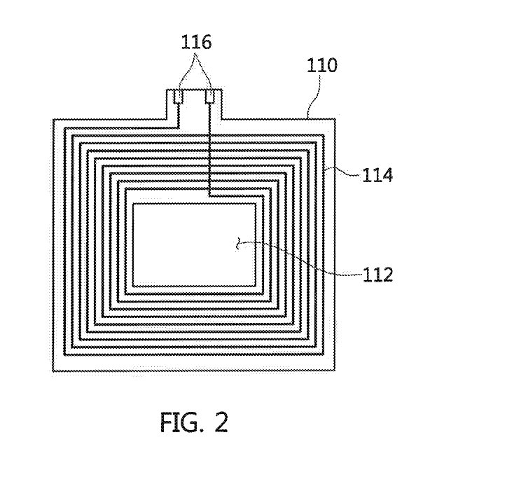

A radiation pattern that resonates at a wireless communication frequency band is formed on the antenna sheet 110. The antenna sheet 110 has a radiation pattern on at least one of the top and the bottom. The antenna sheet 110 may be one sheet with a radiation pattern or may be formed by stacking a plurality of sheets having a radiation pattern. As shown in FIG. 2, the antenna sheet 110 has a non-patterned portion 112, a radiation pattern 114, and a power supply terminal 116.

The non-patterned portion 112 is defined in a predetermined area from the center of the antenna sheet 110 for ideal radiation of a magnetic field. Although the non-patterned portion 112 is formed in the shape of a rectangle in FIG. 2, it is not limited thereto and may be formed in various shapes such as a circle and a polygon.

The radiation pattern 114 is formed in the shape of a loop in which a wire is wound several times around the edge of the non-patterned portion 112. The radiation pattern 114 is wound by predetermined times (number of turn: 1 or more turns) according to inductance that is set in accordance with characteristics of the wireless communication antenna module 100. Both ends of the radiation pattern 114 are connected to the power supply terminal connected with a circuit (that is, a power supply circuit) of a portable terminal.

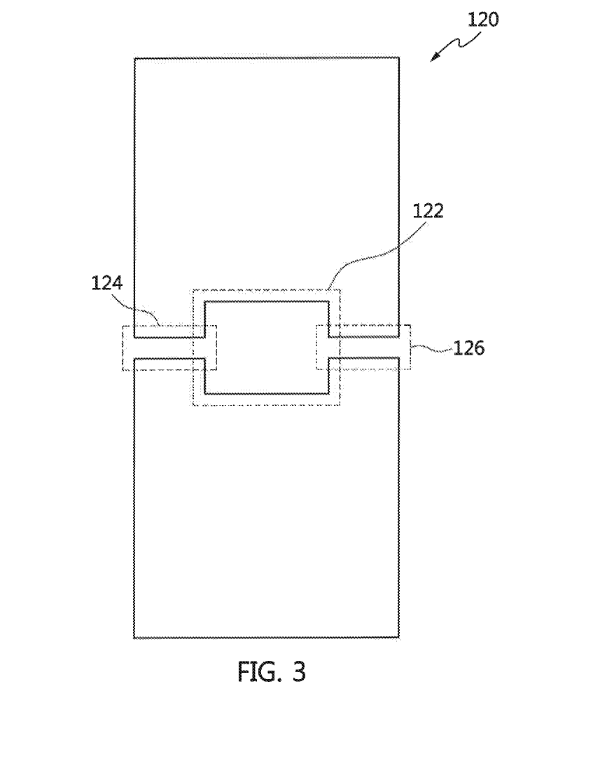

The radiation sheet 120 is made of metal and disposed at the upper portion of the antenna sheet 110 to operate as a sub-radiator of the radiation pattern 114 formed on the antenna sheet 110. The radiation sheet 120 operates as a sub-radiator through magnetic-coupling with the radiation pattern 114 in the area where it overlaps the radiation pattern 114 formed on the antenna sheet 110. To this end, as shown in FIG. 3, the radiation sheet 120 has an opening 122, a first slit 124, and a second slit 126.

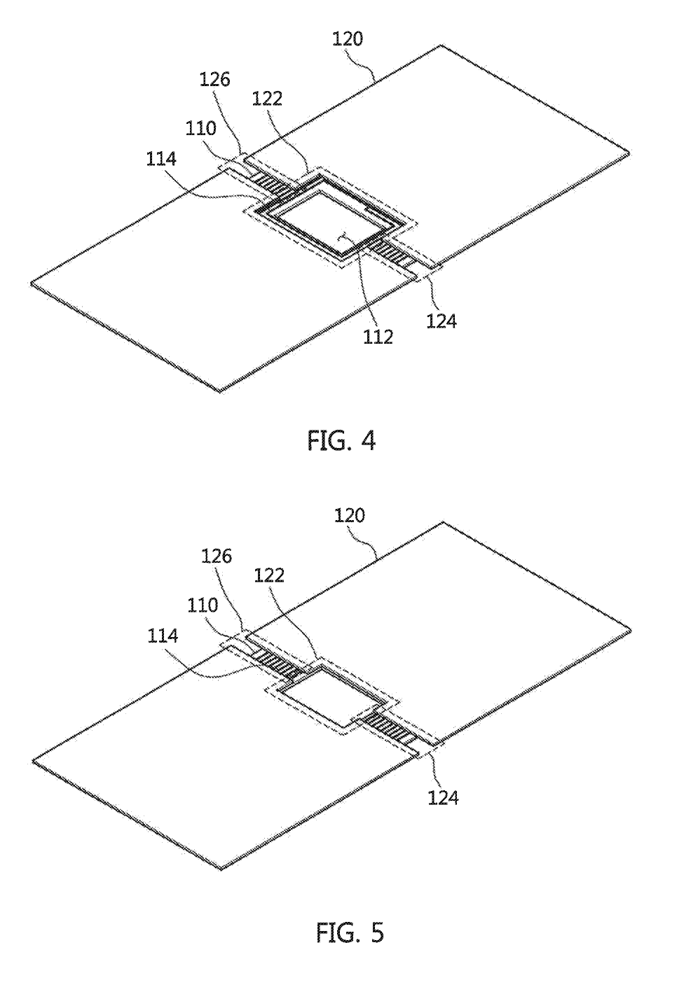

The opening 122 is formed at the center portion of the overlap area where the antenna sheet 110 and the radiation sheet 120 overlap each other. As shown in FIG. 4, the edge of the opening 122 is stacked on an area where the radiation pattern 114 is formed. That is, the opening 122 is formed larger than the non-patterned portion 112 of the antenna sheet 110 and the edge is stacked on the area where the radiation pattern 114 is formed. Accordingly, the edge of the opening 122 is spaced at a predetermined distance from the edge of the non-patterned portion 112.

Obviously, as shown in FIG. 5, the edge of the opening 122 may be stacked on the edge of the non-patterned portion 112. That is, the opening 122 is formed in the same size as the non-patterned portion 112 of the antenna sheet 110 and the edge is stacked on the edge of the non-patterned portion 112. Accordingly, the edge of the opening 122 may coincide with the edge of the non-patterned portion 112.

Although the opening 122 is formed in a rectangular shape in FIGS. 3 to 5, it is not limited thereto and may be formed in various shapes in accordance with the shape of the non-patterned portion 112 formed on the antenna sheet 110.

The first slit 124 extends outward from a side of the opening 122. That is, the first slit 124 extends from the left side of the opening 122 to the left side (left edge) of the radiation sheet 120. The side of the first slit 124 connected to the left side of the opening 122 is stacked on the area where the radiation pattern 114 is formed.

The second slit 126 extends outward from the other side of the opening 122. The second slit 126 is formed opposite to the first slit 124. That is, the second slit 126 extends from the right side of the opening 122 to the right side (right edge) of the radiation sheet 120. The side of the second slit 126 connected to the right side of the opening 122 is stacked on the area where the radiation pattern 114 is formed.

Since the opening 122, the first slit 124, and the second slit 126 are formed in the radiation sheet 120, a portion of the radiation pattern 114 formed on the antenna sheet 110 is exposed inside the opening 122, the first slit 124, and the second slit 126. Accordingly, the radiation sheet 120 operates as a sub-radiator of the radiation pattern 114 through magnetic-coupling with the radiation pattern 114 exposed inside.

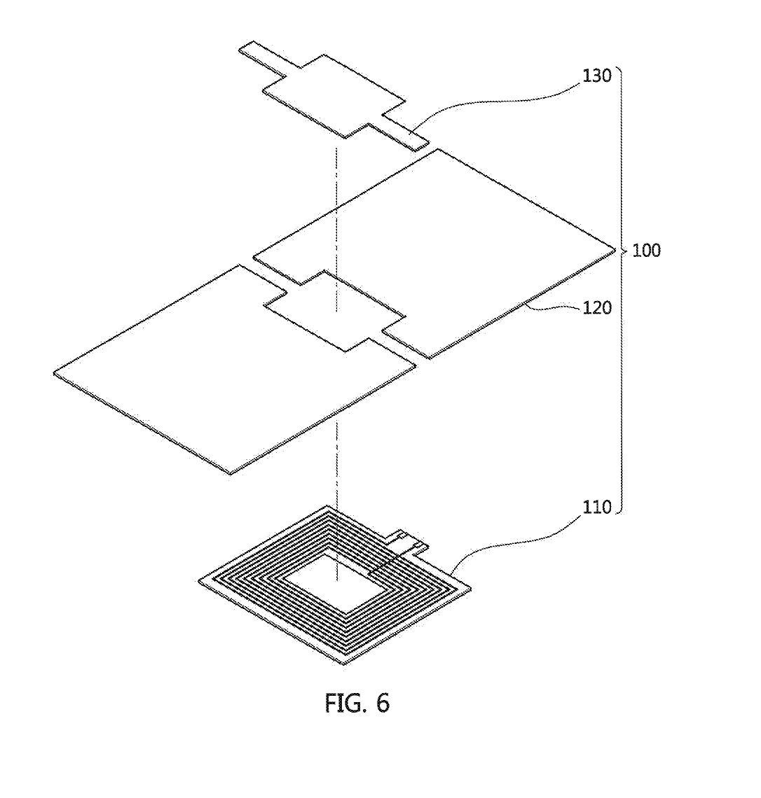

As shown in FIG. 6, the wireless communication antenna module 100 may further include a protective sheet 130.

The protective sheet 130 is made of resin such as plastic and overlaps the opening 112 and the slits 124 and 126. That is, it covers the opening 122, the first slit 124, and the second slit 126 of the radiation sheet 120. The protective sheet 130 prevents damage to the radiation pattern 114 exposed inside the opening 122, the first slit 124, and the second slit 126, Designs such as a logo, a mark, an advertisement, and a phone number of a company may be formed on the protective sheet 130.

Although the antenna sheet 100, the radiation sheet 120, and the protective sheet 130 are formed in one module, it is not limited thereto, and the antenna sheet 100 may be mounted on a portable terminal body or a battery and a side of a rear housing 200 of a portable terminal may be used as the radiation sheet 120 and the protective sheet 130. The radiation sheet 120 is made of metal on a side of the rear housing 200 of a portable terminal. The protective sheet 130 may be made of resin on a side of the rear housing 200 of a portable terminal. Since the rear housing 200 of a portable terminal is combined, the antenna sheet 100, the radiation sheet 120, and the protective sheet 130 operate as one wireless communication antenna module.

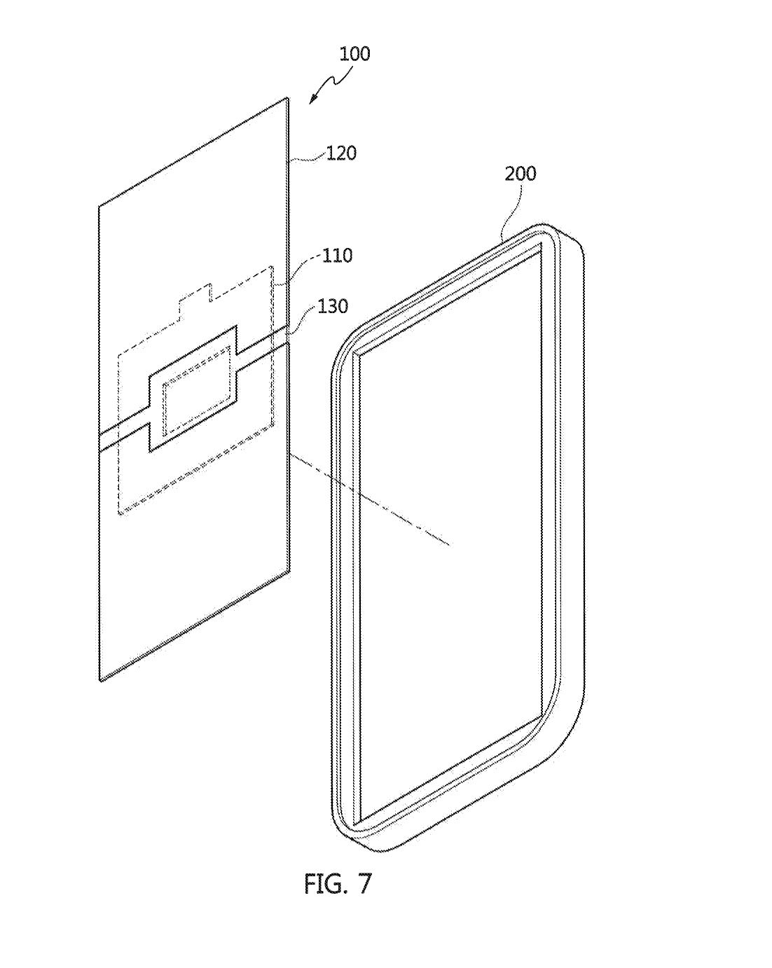

FIGS. 7 to 9 are diagrams illustrating a portable terminal having a wireless communication antenna module according to an embodiment of the present invention.

As shown in FIG. 7, a portable terminal includes the rear housing 200 on which the wireless communication antenna module 100 is mounted. Although the wireless communication antenna module 100 is formed in a rectangular shape in FIG. 7, it may be formed in various shapes in accordance with the shape of the inside of the rear housing 200.

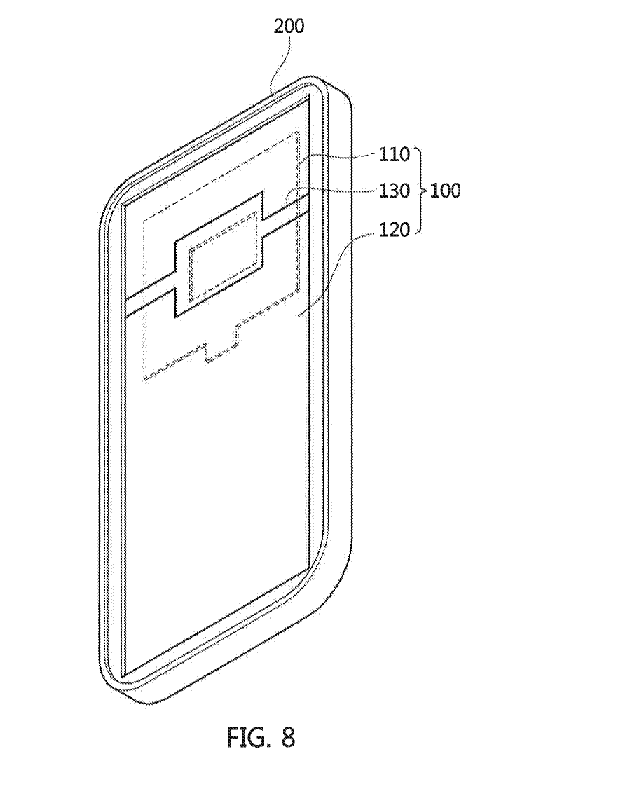

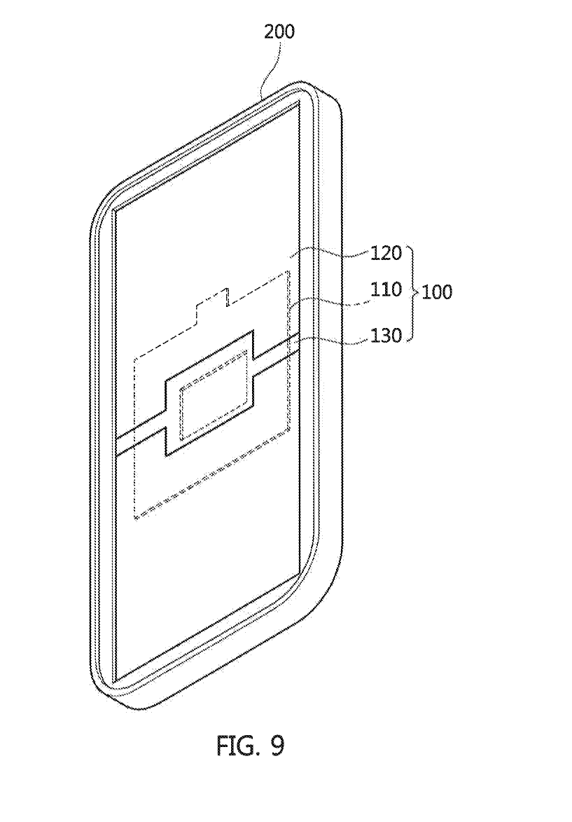

The rear housing 200 is made of resin such as plastic or metal and the wireless communication antenna module 100 is mounted inside the rear housing 200. The wireless communication antenna module 100 may be disposed close to a short side of the housing (see FIG. 8) or may be disposed at the center portion (see FIG. 9).

Accordingly, the antenna sheet 110 has the radiation pattern 114 thereon and is stacked inside the rear housing 200 (that is, toward the body of the portable terminal).

The radiation sheet 120 is stacked at the upper portion of the antenna sheet 110 such that the opening 122 overlaps the radiation pattern 114. That is, it overlaps a portion of the radiation pattern 114 formed on the antenna sheet 110 through the opening 122, first slit 124, and second slit 126 formed in the radiation sheet 120. Accordingly, it operates as a sub-radiator through magnetic-coupling with the radiation pattern 114 exposed outside.

Thereafter, the protective sheet 130 is stacked to cover the opening 122, the first slit 124, and the second slit 126 to protect the exposed radiation pattern 114.

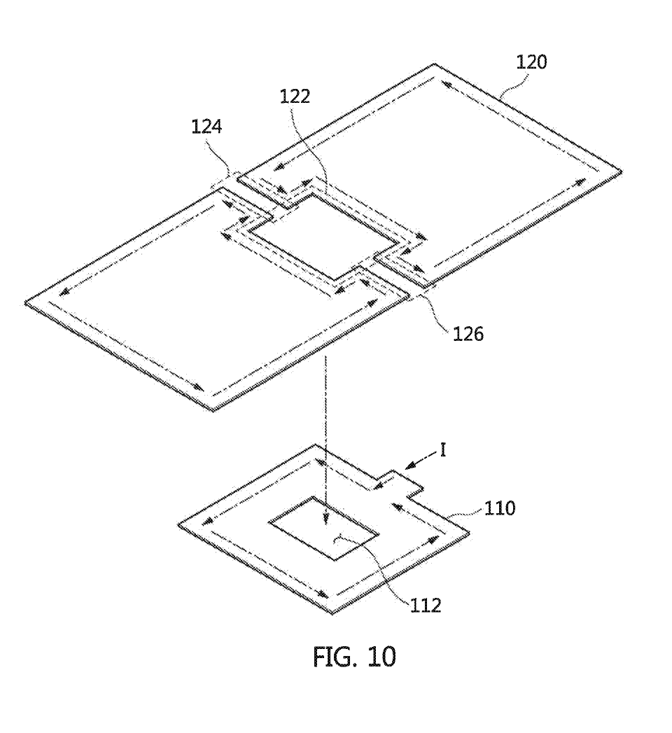

FIG. 10 is a diagram illustrating current flow when a wireless communication antenna module according to an embodiment of the present invention is operated. Referring to FIG. 10, when power is applied from a power supplier of a portable terminal, a current I is applied to the radiation pattern 114 of the antenna sheet 110. Accordingly, a counterclockwise current flows in the radiation pattern 114. Magnetic flux is generated by the counterclockwise current in the radiation pattern 114. The magnetic flux generated in the radiation pattern 114 is intended to link to the radiation sheet 120, so an induced current in the opposite direction to the current flowing in the radiation pattern 114 (that is, a clockwise induced current) is generated around the opening 122 of the radiation sheet 120. The induced current generated in the radiation sheet 120 circulates around the edge of the radiation sheet 120. Accordingly, in the wireless communication antenna module, the radiation area of the magnetic field increases and a magnetic flux loop is increased by the radiation sheet 120.

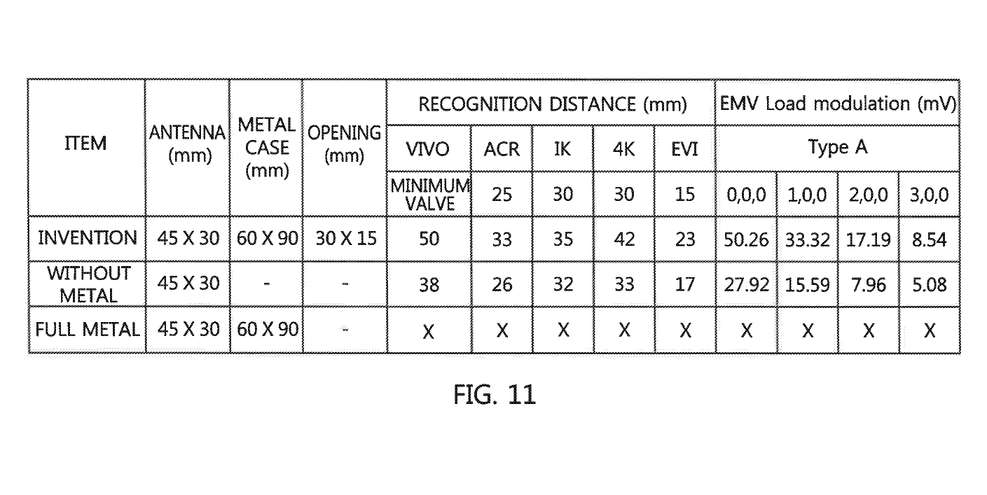

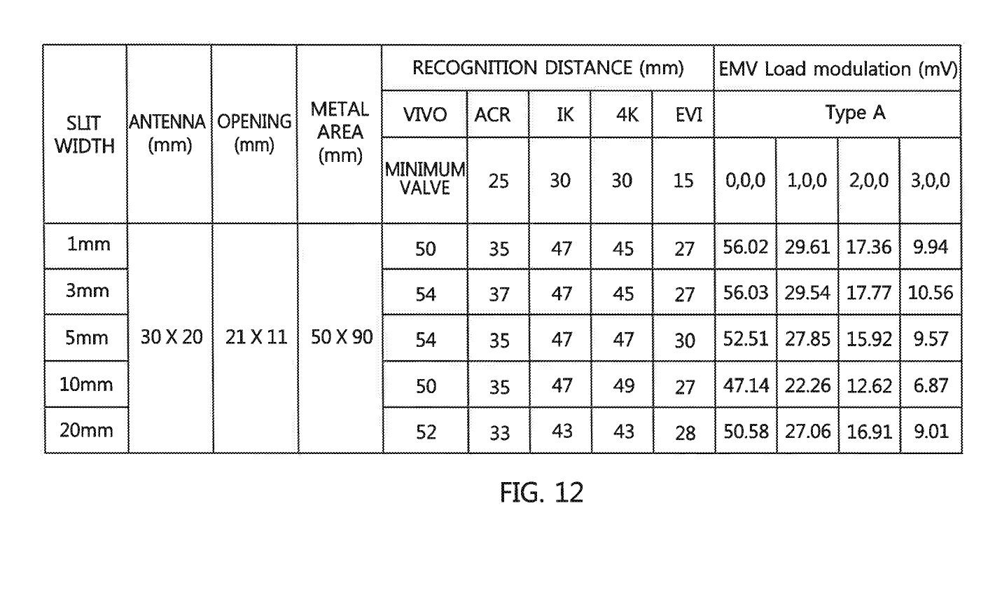

FIGS. 11 to 13 are diagrams illustrating antenna characteristics of a wireless communication antenna module according to an embodiment of the present invention.

FIG. 10 shows antenna characteristics of a wireless communication antenna module of the present invention, a wireless communication antenna module without a radiation sheet of the related art, and a wireless communication antenna module with a radiation sheet without an opening and a slit.

From the figure, it can be seen that the wireless communication antenna module of the present invention has improved antenna performance because a recognition distance and an EMV Load modulation characteristic in a reader mode are increased, as compared with the wireless communication antenna module without a radiation sheet of the related art and the wireless communication antenna module with a radiation sheet without an opening and a slit.

FIG. 11 shows antenna characteristics according to different widths of the slits 124 and 126 formed in the radiation sheet in the wireless communication antenna module of the present invention. FIG. 11 shows data measured with the entire size of the antenna sheet 110, the size of the opening 122, and the size of the radiation sheet 120 maintained and with the widths of the slits changed to 1 mm, 3 mm, 5 mm, 10 mm, and 20 mm.

From this figure, it can be seen that when the widths of the slits 124 and 126 are equal to or less than the length of a side of the opening 122, the recognition distance and the EMV Load modulation of the wireless communication antenna module 100 of the present invention in a reader mode are increased and the antenna performance is improved.

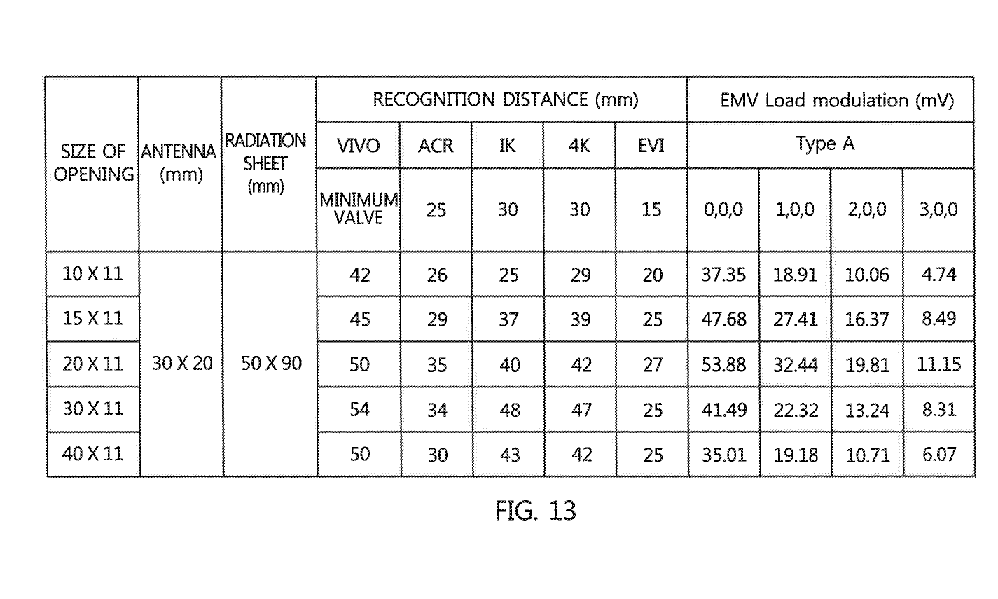

FIG. 13 shows antenna characteristics according to different sizes of the opening formed in the radiation sheet 120 in the wireless communication antenna module 100 of the present invention. FIG. 13 shows data measured with the entire size of the antenna sheet 110, the size of the radiation sheet 120, and the widths of the slits maintained and with the size of the opening 122 changed to 10×11, 15×11, 20×11, 30×11, and 40×11.

From this figure, it can be seen that when the size of the opening 122 is equal to or larger than inner circumference and smaller than the outer circumference of the radiation pattern 114, the recognition distance and the EMV Load modulation of the wireless communication antenna module 100 of the present invention in the reader mode are increased and the antenna performance is improved.

As described above, since an opening and a plurality of slits are formed in a radiation sheet and the radiation sheet is stacked on a radiation pattern in the wireless communication antenna module, the radiation area of a magnetic field is increased by magnetic-coupling between the radiation pattern and the radiation sheet and the magnetic flux loop is increased by the radiation sheet, so the antenna performance can be maximized.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A wireless communication antenna module comprising:
an antenna sheet having a radiation pattern formed in a loop shape by winding a wire several times along an edge of a non-patterned portion; and
a radiation sheet stacked on the antenna sheet,
wherein the radiation sheet has an opening and a plurality of slits, and the opening and the slits are stacked to form an overlap area with the radiation pattern.

2. The wireless communication antenna module of claim 1, wherein an edge of the opening formed in the radiation sheet is stacked on an area where the radiation pattern is formed.

3. The wireless communication antenna module of claim 1, wherein an edge of the opening formed in the radiation sheet is stacked on the edge of the non-patterned portion.

4. The wireless communication antenna module of claim 1, wherein the radiation sheet includes;
a first slit extending in a first direction from a first side of the opening; and
a second slit extending in a second direction from a second side of the opening.

5. The wireless communication antenna module of claim 4, wherein the second slit is disposed opposite to the first slit.

6. The wireless communication antenna module of claim 4, wherein a side connected to the first side of the opening of the first slit is stacked on an area where the radiation pattern is formed.

7. The wireless communication antenna module of claim 4, wherein a side connected to the second side of the opening of the second slit is stacked on an area where the radiation pattern is formed.

8. The wireless communication antenna module of claim 1, further comprising a protective sheet overlapping the opening and the slits.

9. A portable terminal comprising:
a portable terminal body;
a rear housing mounted on a rear side of the portable terminal body; and
a wireless communication antenna module mounted inside the rear housing,
wherein the wireless communication antenna module is the wireless communication antenna module of claim 1.

10. The portable terminal of claim 9, wherein a radiation sheet of the wireless communication antenna module is included in the rear housing.
